(19) United States
(12) Patent Application Publication
(10) Pub. No.: US 2002/0118858 A1
(43) Pub. Date: Aug. 29, 2002

(54) Loudspeaker system

(76) Inventors: Ted E. White, Newmarket (CA); Raymond A. Yap, Aurora (CA); Chris Vanier, Chicago, IL (US); Mike H. Doell, Toronto (CA); Joseph A. Castaldi, Woodbridge (CA); William Bryant, Aurora (CA)

Correspondence Address: Ralph A. Dowell, Dowell & Dowell, Suite 309, 1215 Jefferson Davis Highway, Arlington, VA, 22202-3124, US

(21) Appl. No.: 09/985,158

(22) Filed: Nov. 1, 2001

Related U.S. Application Data
(63) Continuation of application No. PCT/CA00/00466, filed on May 1, 2000.
(60) Provisional application No. 60/132,231, filed on May 3, 1999.

(51) Int. Cl. H04R 1/02; H04R 1/00; H04R 11/02; H04R 1/20; H04R 9/06; H04R 25/00

(52) U.S. Cl. 381/430; 381/338; 381/386; 381/387; 381/336; 381/182; 381/345

(57) ABSTRACT

A reflection speaker assembly includes a cylindrical body having an aperture, a reflector, a tweeter type speaker for higher frequencies and a midrange type of speaker for middle frequencies. The tweeter is located on the wall of the cylindrical body. The midrange is mounted inside the body. The aperture is located between a base containing the reflector and a housing containing the midrange speaker. In one embodiment, the reflector is positioned opposite the midrange speaker in the body and comprises in a flat surface set at an angle relative to the midrange speaker. In a second embodiment, the reflector is positioned opposite the midrange speaker in the body and is roughly conical. Sound waves radiated from the midrange speaker are reflected by the reflector, and are dissipated to the outside through the aperture.

### BACKGROUND OF THE INVENTION

1. Field of the Invention

The present invention generally relates to the field of loudspeaker systems, and more particularly to a cylindrical reflection-type loudspeaker assembly.

2. Description of the Prior Art

The prior art is prolific with respect to various types of loudspeaker designs for use in music systems. Known speaker systems range from extremely compact type speakers within baffled cabinets to fairly large rectangular-shaped speaker cabinets incorporating one or more loudspeakers. The use of flat-faced speaker cabinets are believed to cause undesirable diffraction of higher frequency sound waves because waves diffract at the edge of the face or baffle board. Furthermore, as discussed in U.S. Pat. No. 5,446,792, the larger the angle from the central axis of the speaker direction and the higher the frequency of the speaker, the less the sound pressure level. Thus, since the sound pressure level is what makes a particular frequency audible, the higher frequencies become less audible at greater angles away from the central axis of the speaker direction.

Some speaker systems alleviate this problem by using a cylindrical frame for the cabinet (see, for example, U.S. Pat. Nos. 3,945,461, 4,223,760, 5,091,959 and 5,446,792). However, the use of an elongated cylindrical cabinet presents difficulties. For example, it is difficult to mount a midrange speaker diaphragm or a woofer diaphragm on the cylinder, unless it is placed in the open end of the cylinder. Placing a midrange or woofer speaker on the open end is problematic because the speaker is then oriented such that the sound produced by the speaker can only be directed along the axis of the cylinder. U.S. Pat. No. 5,446,792 addresses this problem with a structure that includes an aperture and an asymmetrical cone to reflect the sound waves. However, this design is an inefficient reflector and does not address the inclusion of a tweeter system in the speaker for reproduction of higher frequency ranges. U.S. Pat. No. 5,485,521 discloses a speaker assembly with a cylindrical housing with an axial speaker and an adjustable inclined reflector for dissipating the sound waves from the axial speaker. A second speaker is located on a planar facet of the housing to supplement the axial speaker. However the mounting of the second speaker limits the dispersion of the sound waves and introduces the diffraction characteristics that are attributable to flat faced speaker cabinets. The adjustable nature of the reflector also limits the orientation of the speaker assembly when in use.

It is therefore an object of the present invention to obviate or mitigate the above disadvantages.

### SUMMARY OF THE INVENTION

In accordance with one aspect of the present invention, a speaker assembly comprises

a) a body having a cylindrical peripheral wall;

b) a first speaker located in the body for radiating sound waves along a longitudinal axis of the body;

c) an aperture located in the cylindrical body;

d) a reflecting surface positioned opposite the first speaker for reflecting the sound waves from the first speaker through the aperture; and

e) a second speaker located in the peripheral wall for radiating sound waves radially from the body; the second speaker having an outlet conforming to the curvature of the wall.

Preferably the body includes a speaker housing and a base, with the base extending from and integral with said housing.

Preferably also the first speaker is a midrange speaker and the second speaker is a high frequency speaker.

As a further preference the reflecting surface is planar.

In a preferred embodiment, the cylindrical body has a longitudinal axis and is positioned such that the axis is vertical. The midrange speaker projects sound downwards and the high frequency speaker projects sound outwards from the body in a direction perpendicular to a front of the high frequency speaker. The reflecting surface reflects some sound outwards from the cylinder in a direction perpendicular from the front of the speaker. Preferably, the angle between horizontal and the reflecting surface is 30°.

In another embodiment, the speaker assembly has the reflecting surface located on a base with a support connected to the base and projecting upwardly from the base. A line is connected to the support, for suspending the first speaker over the reflecting surface. Alternatively, the reflecting surface is roughly conical, or it may be a cone. In one embodiment, the conical center of the reflecting surface is offset from the centre of the midrange speaker. In another embodiment, the reflecting surface is curved convexly.

Preferably, the body has a diameter of between 4 inches (9.5 cm) and 4.5 inches (11 cm), and preferably has a height of 7.5 inches (18 cm).

The invention also provides a speaker system comprising a plurality of speaker assembly described above, and a subwoofer for producing low frequency sound waves.

### BRIEF DESCRIPTION OF THE DRAWINGS

Embodiments of the invention will now be described by way of example only with reference to the accompanying drawings, in which:

FIG. 1 is a perspective view illustrating a reflection speaker assembly,

FIG. 2 is a front view of the reflection speaker assembly of FIG. 1,

FIG. 3 is a side view of the reflection speaker assembly of FIG. 1,

FIG. 4 is a longitudinal section on the line IV-IV of FIG. 1,

FIG. 5 is a section on the line V-V of FIG. 1,

FIG. 6 is a section on the line VI-VI of FIG. 5,

FIG. 7 is an exploded view showing the components of the speaker assembly of FIG. 1,

FIG. 8 is a side view of a second embodiment of a reflection speaker assembly,

FIG. 9 is a perspective view of a third embodiment of reflection speaker assembly,

FIG. 10 is a perspective view of a fourth embodiment of reflection speaker assembly, and

FIG. 11 is a perspective view of a fifth embodiment of reflection speaker assembly.

### DESCRIPTION OF THE PREFERRED EMBODIMENTS

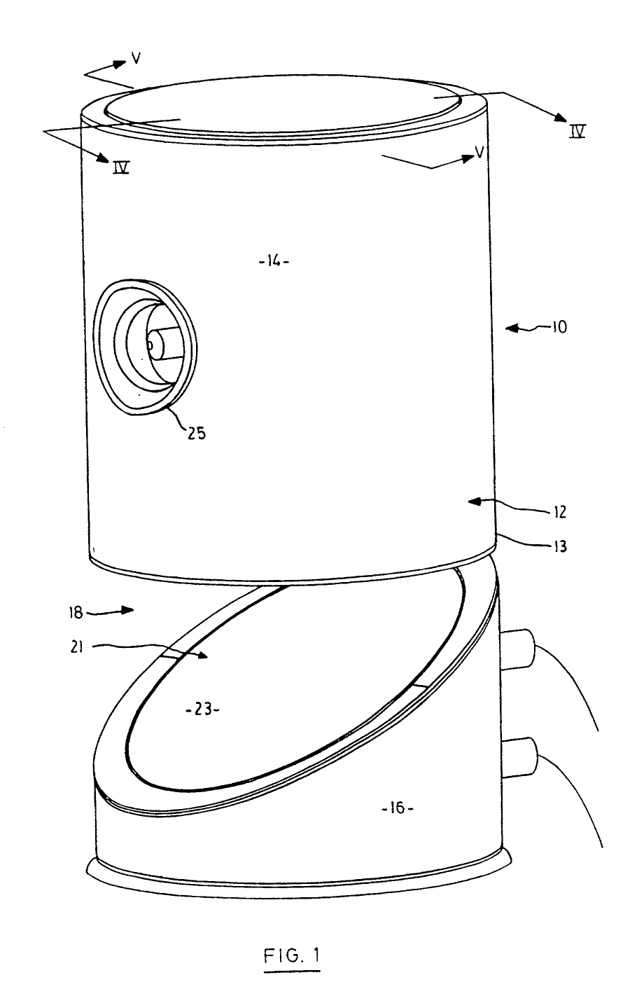

Referring firstly to FIG. 1, a loudspeaker assembly 10 is provided having a body 12 with a speaker housing 14 and a base 16. Opposed surfaces of the housing 14 and base 16 diverge to provide a cuneiform aperture 18. The loudspeaker assembly 10 may be used in an audio system, which includes a subwoofer type speaker for producing lower frequency audio and a plurality of reflection speaker assembly for producing high and midrange frequency audio. In such a system, the subwoofer type speaker is preferably placed centrally relative to the other speaker assembly. The other speaker assembly are preferably placed at various points, for example at four or five locations, relatively equidistant from each other and relatively equidistant from the central location referred to. The central location is the location where the listener enjoys the best quality of sound produced by the speaker system. Alternatively, the speaker assembly may be used as a stand-alone unit.

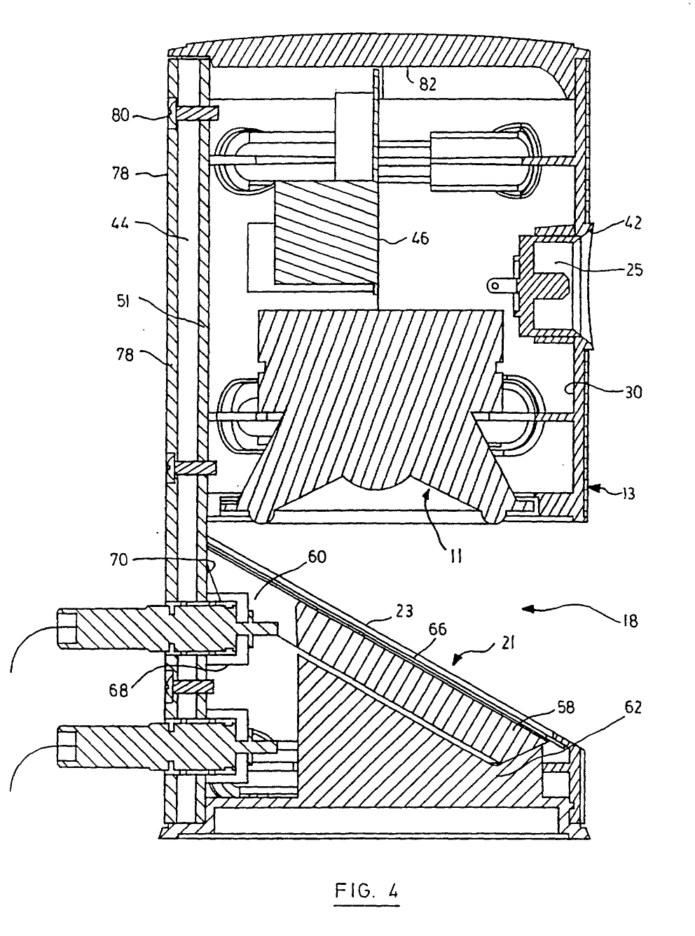

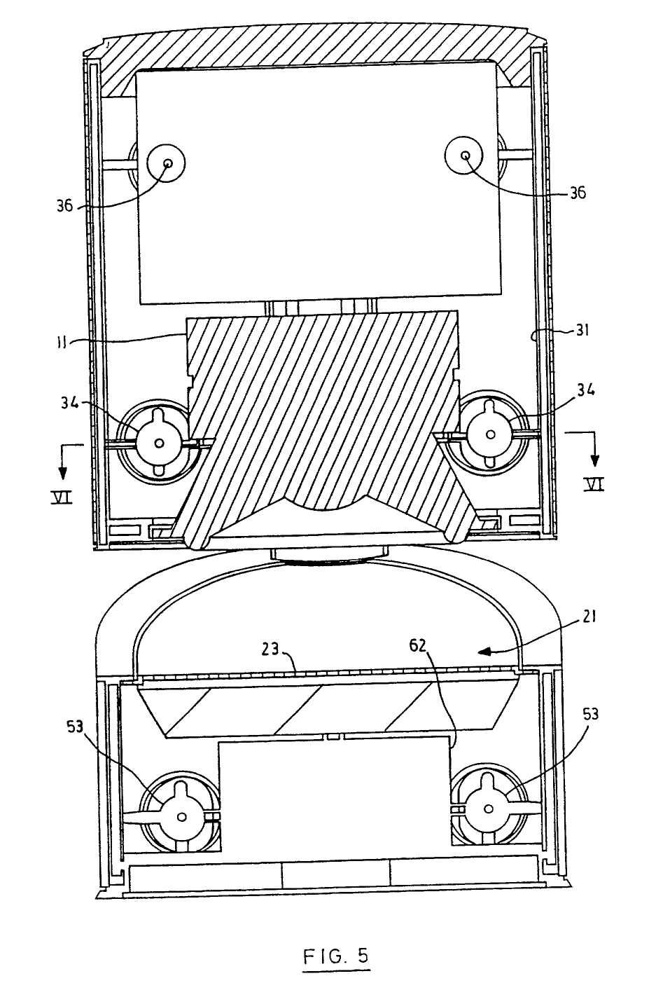

The body 12 is cylindrical with a peripheral wall 13. As can best be seen in FIGS. 4 and 5, a speaker 11 is mounted inside housing 14 and at one end, the opposite end being closed by an end wall 16. Speaker 11 radiates sound parallel to the central longitudinal axis A-A of housing 14.

A reflecting structure 21 includes a planar surface 23 inclined to the central axis A-A. Surface 23 of the reflecting structure 21 is arranged to reflect sound waves generally radially over a wide segment. Reflecting surface 23 is located in base 16 so as to be in fixed relationship to the housing 14 and define the aperture 18.

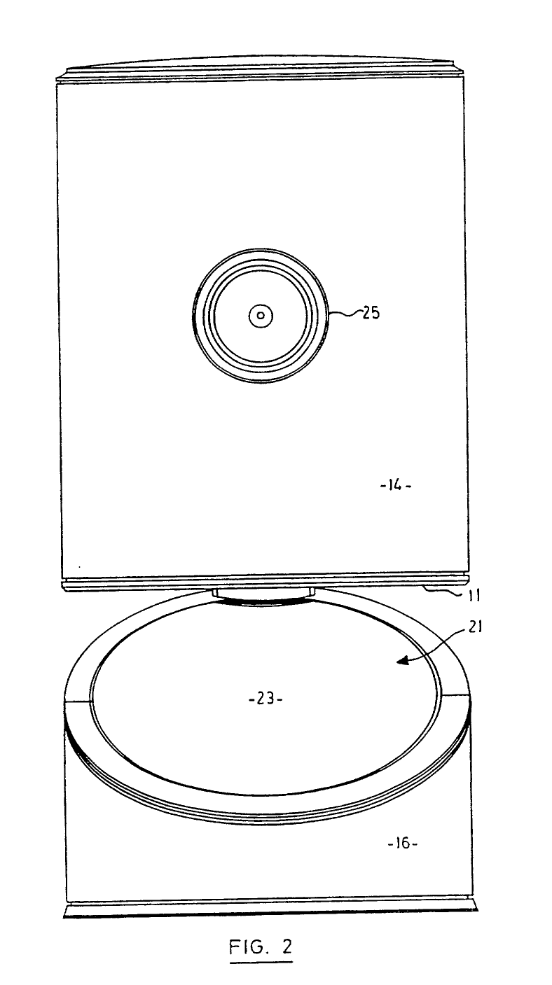

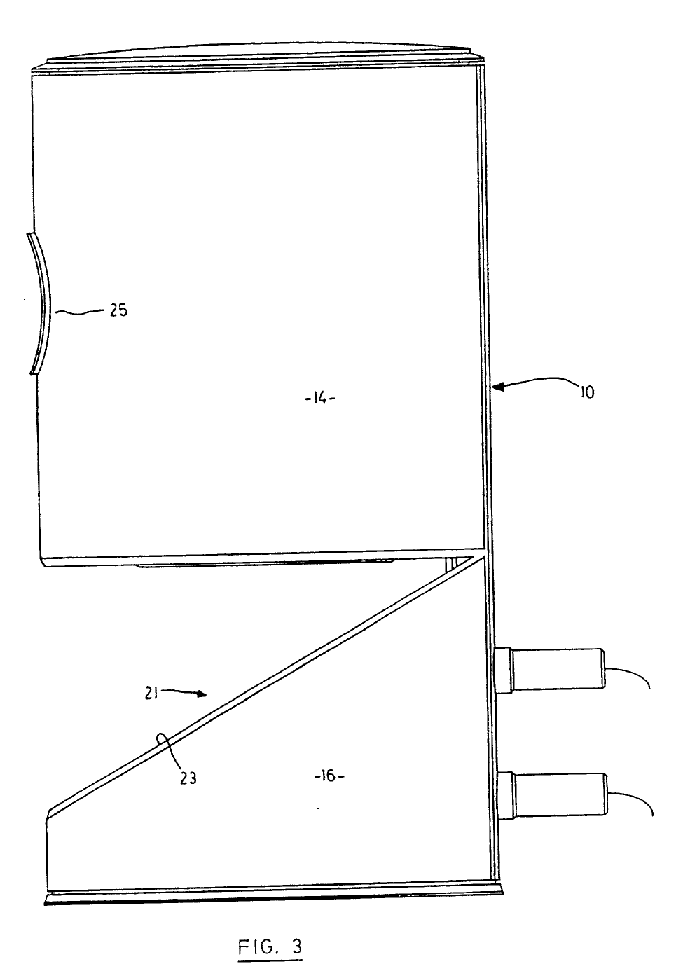

To provide higher frequencies of sound, a tweeter 25 is located on the wall 13 and is positioned to direct sound perpendicularly from the axis of housing 14. The “front” of speaker 11 is defined by the position of tweeter 25, i.e. the central axis of the speaker direction of tweeter 25 is perpendicular to the front of the speaker. As can be seen from FIGS. 1 to 4, the tweeter 25 conforms to the curved surface of the wall 13 so as to merge smoothly with it. The inclusion in a curved surface allows the sound to disperse around the exterior of the housing 14 without encountering defraction producing edges.

In the embodiment shown, the speaker 11 is a midrange speaker which fires down while the tweeter 25 fires forward. In this preferred embodiment, the body 12 is vertically disposed and sound waves radiating from midrange speaker 11 are reflected and radiated out by reflecting structure 21, such that the primary direction of radiation is parallel the central axis of the speaker direction of tweeter 25.

The angle between the front face of speaker 11 and reflecting surface 23 is in the range of 20 to 45 degrees, more preferably 25 to 35 and most preferably 30 degrees. This angle has been found to produce preferred acoustical effects. This selected angle allows the sound to dissipate from the speaker assembly 10 in a horizontal and vertical fashion.

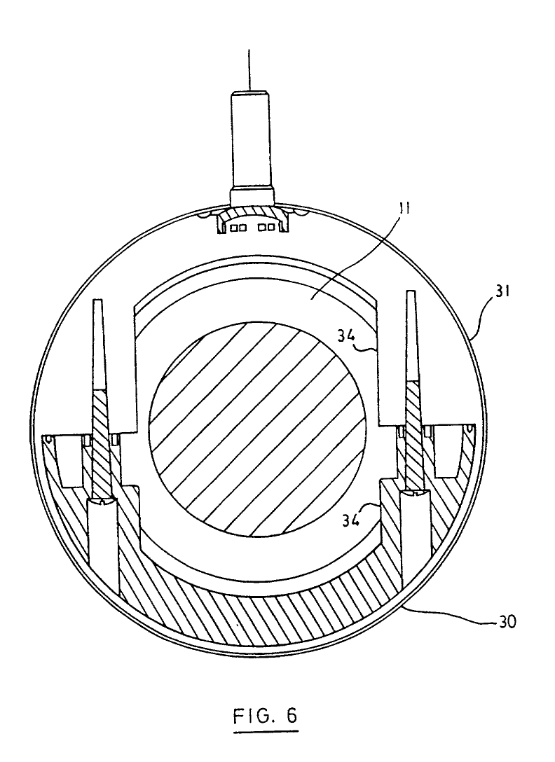

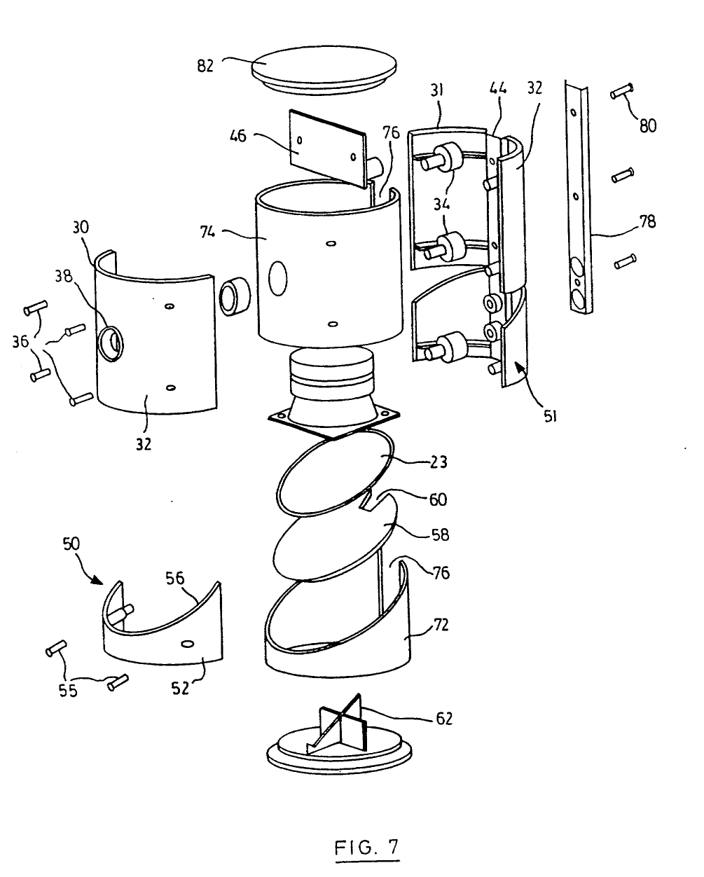

The details of the construction of the speaker assembly 10 are best seen in FIGS. 4 to 7. The speaker housing 14 is formed from a pair of plastic shells 30, 31, each of which has a cylindrical outer wall 32 and connecting lugs 34. Bolts 36 extend through the lugs 34 to secure the shells 30, 31, to one another. The forward facing shell 30 has a circular aperture 38 in the outer wall 32 to receive the tweeter 25. As can be seen in FIG. 4, the tweeter 25 is supported in a cylindrical boss 40 integrally molded with the outer wall 32 and having a peripheral lip 42 extending about the periphery of the intersection with the outer wall 32.

The rear facing shell 31 has an axial channel 44 that opens rearwardly. The upper set of lugs 34 act to locate a printed circuit board 46 that carries the electronic components of the crossover circuit. The lower edge of the shells 30, 31 is molded to receive the periphery of the speaker 11 and axially locate it.

The base 16 is similarly formed from a pair of shells 50, 51, with outer walls 52, which are connected to one another by bolts 53 extending through lugs 54. The base 16 has an upper edge 56 that is inclined to the axis A-A and supports the reflector structure 21. The structure 21 has a base plate 58 of significant thickness and formed from a relatively dense material such as iron. A notch 60 is provided in the rear edge of the plate 58 to accommodate internal wiring and the plate 58 is supported on a spider 62 molded in to a lower end plate 64. The periphery of the plate 58 is supported on the edge 56 and has the reflector 23 secured to its upper surface by an adhesive 66.

The rear shell 51 is molded with a pair of sockets 68 to receive the speaker wires and establish connections to the internal wiring connected to the circuit board 46. A channel 70 complementary to channel 44 is formed in the rear shell 51.

The outer peripheral wall 13 is formed by a pair of aluminum skins 72, 74, that wrap around the upper pair of shells 30, 31 and lower pair of shells 50, 51 respectively. Each of the skins 72, 74 is cylindrical with a discontinuity at the rear. A pair of inwardly directed lips 76 are formed on opposed edges to locate in channels 44, 70 and hold the skins 72, 74 snugly against the outer walls 32, 52 respectively. A spine 78 is received in each of the channels 44, 70, and is secured by bolts 80. The spine 78 is a channel section and cooperates with the channels 44, 70, to define an internal passageway for the internal wiring from the sockets 68 to the circuit board 46. The upper end of the housing 14 is closed by an end plate 82 to seal the interior of the housing.

It will be noted from FIG. 4 that the skin 72 is snugly received against the lip 42 on the outer wall 32 so that a relatively smooth transition is provided from the tweeter to the outer surface 13. The cylindrical design of the outer surface and the smooth transition allows frequencies from the tweeter 25 to wrap around the speaker assembly 10 without interference or diffraction effects from the speaker assembly itself.

The body 12 is dimensioned such that its length is preferably 7.5 inches (18 cm) and its outside diameter is preferably between 4 inches (9.5 cm) and 4.5 inches (11 cm), preferably about 4 inches (9.5). The skins 70, 72, are made of a metal, preferably aluminum, and preferably having a thickness of about ⅛^{th} inch (0.3 cm). This choice of material appears to cause some high frequency sound to emit through wall 13. Some wavelengths emitted from the tweeters are very short and the cylindrical configuration and it's relative diameter appears to effectively allow some or all of these frequencies to emit from all directions from the housing 14. Therefore, high frequency sound produced by the tweeter emits in a somewhat omni-directional manner, thus reducing variation of the sound pressure level at different angles of location from the front of the speaker assembly 10. The shells 30, 31, and 50, 51, are preferably made of ABS.

The orientation of reflecting face 23 and reflecting structure 21 is geometrically selected to allow midrange frequencies to travel from the speaker into a room in a wide dispersion pattern. The dispersion is about 280 degrees, resulting in a sound production roughly equivalent to bi-polar design speaker, without the additional costs associated with a bi-polar design speaker.

The reflecting surface 23 provides reflections from the speaker assembly itself and does not rely on the local reflection surfaces surrounding the speaker assembly for reflected sound or indirect sound. The speaker assembly provides both direct and indirect sound from the speaker assembly itself.

The construction of the housing 14 and base 16 provides support for the speakers 11, 25, and this eliminates or reduces the need for bracing or shielding of the transducers located in the drivers of the speakers. Similarly, the connection between the base 16 and housing 14 permits the speaker assembly 10 to be set in a number of different orientations as best suited to particular orientations. The speaker 11 is chosen for its mid-range characteristics and the tweeter 25 for its high range characteristics. The crossover circuit will control the speaker 11 to be excited in a range of typically 200-4000 Hz. and the tweeter 25 in the range 4000 Hz. to 20,000 Hz.

The surface 23 is chosen to provide desirable reflective qualities and aluminum or steel is preferred. It may also be a relatively hard surface such as titanium to enhance sound transmission if desirable. The reflecting surface 23 may be constructed of polyvinyl chloride, wood, wood composite, or any material known in the art.

The surface 23 may be finished in an aesthetically pleasing manner to suit the installation. The finishing on the peripheral surface 13 of housing 14, and base 16 may be spun metal (grade 6006) aluminum, or in other embodiments may be powered coated or anodized finish. It appears that the anodized and powder coat finish may improve the sound quality of the speaker assembly.

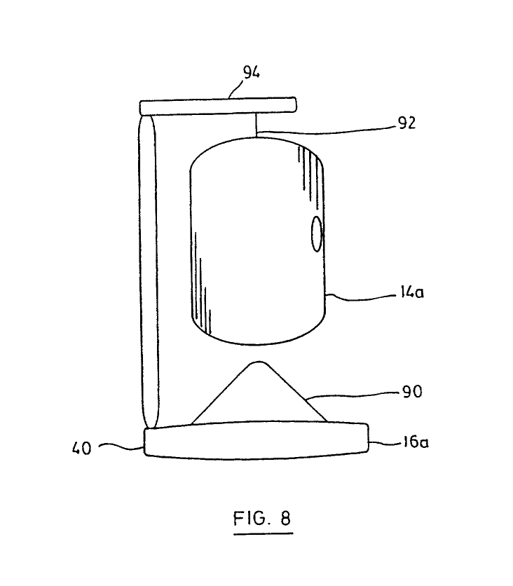

A further embodiment of speaker assembly is shown in FIG. 8 where like reference numerals will denote like components with a suffix ‘a’ added for clarity. The housing 14a locates a midrange speaker 11a and tweeter 25a as described above. A reflecting structure 21a is located opposite the speaker 11a and is formed as a cone 90. To maintain a spaced relationship between the speaker 11a and cone 90, the housing 14a hangs from a line 92, attached to an arm 94 projecting upwardly from the base 16a. The suspension from the line 92 does not allow significant energy transfer from the speaker to the base 16a other than the sound transmitted from the speaker 11a itself to the room. Line 92 may be made of any suitable material, and in preferred embodiment is made from a steel cable.

In the speaker assembly of this embodiment, sound waves radiated from speaker 11a are reflected and radiated by a cone 90 of reflecting structure 21a. This roughly conical reflector assembly causes midrange frequency sound to emit in a roughly omni-directional manner. Therefore, variation of the sound pressure level at different angles of location from the front of the speaker is reduced. This embodiment produces a 360 degree dispersion of midrange sound waves.

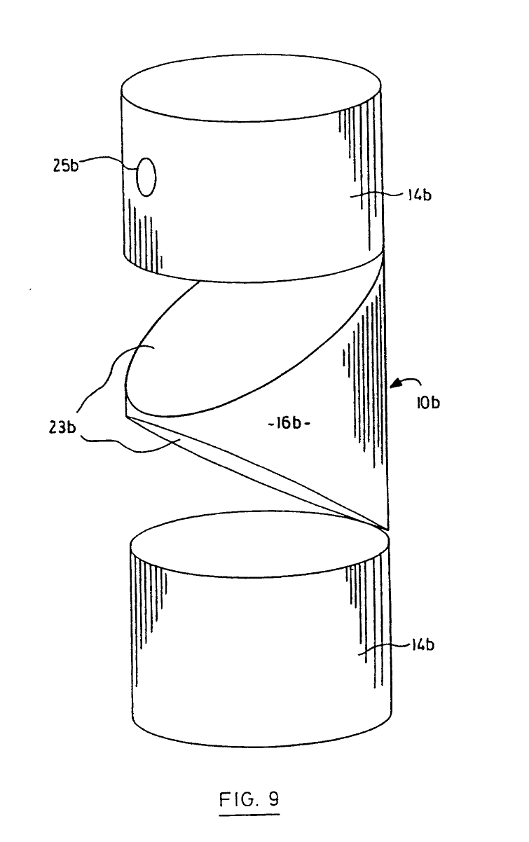

Further embodiments are shown in FIGS. 9 to 11 in which suffixes “b”, “c”, and “d” will be used to denote like components.

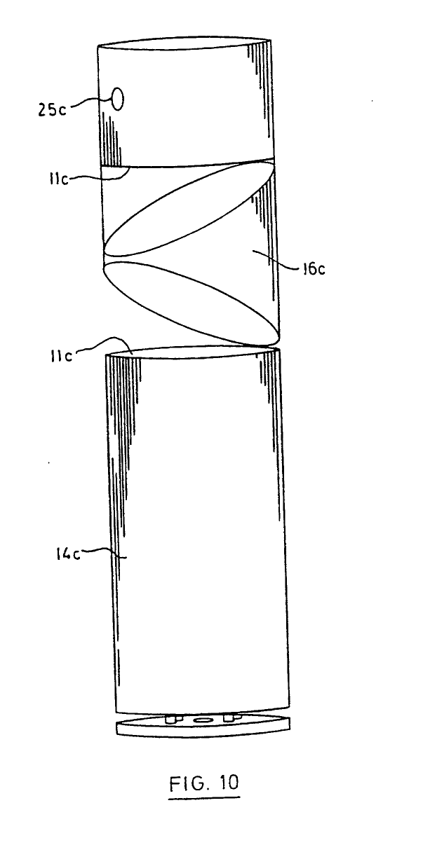

As can be seen in FIG. 9, speaker assembly 10b is essentially formed as a pair of speaker assemblies 10 placed end to end. A single tweeter 25b is located in one of the housings 14b with a mid range speaker 11b. A low range or woofer is located in the other base 14b to provide a full range. A similar arrangement is shown in FIG. 10 with an elongated lower housing 14c to elevate the speakers 11c, 25c. In this case one or a pair of woofers in a bipolar arrangement may be located in the base 14c.

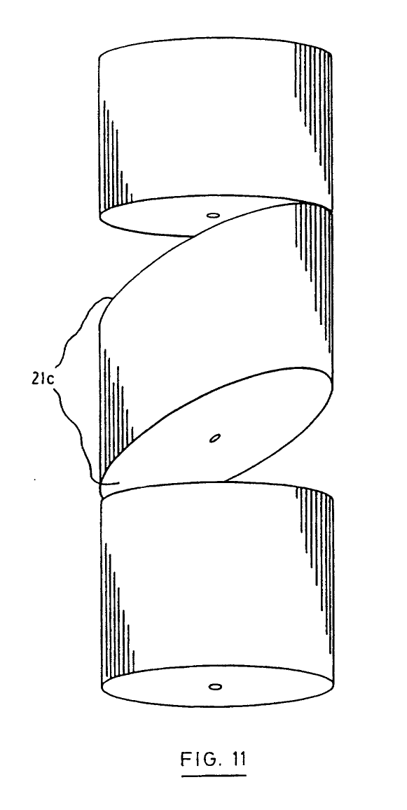

In FIG. 11, the reflecting surfaces 21c are parallel to one another on opposite sides of the base 16c.

In each of the embodiments, the surface 23 of the reflecting structure 21 provides controlled dispersion from the mid-range speaker 11a into the surrounding area. In a further preferred embodiment, not shown, reflecting surface 35 could have a curved convex surface providing superior dispersion patterns to the surrounding area. Since sound waves are radiated from surface 23 outside of housing 14, the radiation energy is more efficiently released.

In another embodiment, not shown, the location or shape of conical reflecting structure 21a can be positioned such that the centre of the cone 90 is offset from the centre of speaker 11a. In this way, more sound can be reflected in one direction than the opposite direction. This embodiment thus provides a speaker assembly that has some directional qualities and some omni-directional qualities.

While the present invention has been illustrated and described in detail in the drawings and foregoing description, it should be recognized that other embodiments will be apparent to those skilled in the art. It is therefore intended that the following claims cover any such embodiments as fall within the scope of the invention.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1) A speaker assembly comprising:
f) a body having a cylindrical peripheral wall;
g) a first speaker located in said body for radiating sound waves along a longitudinal axis of said body;
h) an aperture located in said cylindrical body;
i) a reflecting surface positioned opposite said first speaker for reflecting said sound waves from said first speaker through said aperture; and
j) a second speaker located in said peripheral wall for radiating sound waves radially from said body; said second speaker having an outlet conforming to the curvature of said wall.

2) A speaker assembly as claimed in claim 1, wherein said body includes a speaker housing and a base, said base extending from and integral with said housing.

3) A speaker assembly as claimed in claim 1, wherein said first speaker is a midrange speaker and said second speaker is a high frequency speaker.

4) A speaker assembly as claimed in claim 3, wherein said reflecting surface reflects sound emanating from said midrange speaker so as to propagate radially.

5) A speaker assembly as claimed in claim 3, wherein said reflecting surface is planar.

6) A speaker assembly according to claim 5 wherein said aperture is defined between said planar surface and an end face of said first speaker.

7) A speaker assembly according to claim 6 wherein said aperture has an included angle of between 20 and 40 degrees.

8) A speaker assembly according to claim 7 wherein said aperture has an included angle of between 25 and 30 degrees.

9) A speaker assembly according to claim 8 wherein said aperture has an included angle of 27 degrees.

10) A speaker assembly as claimed in claim 5, wherein said reflecting surface is aluminum.

11) A speaker assembly as claimed in claim 5, wherein said reflecting surface is backed by a support plate.

12) A speaker assembly as claimed in claim 11 wherein said reflecting surface is supported on a peripheral edge of said base.

13) A speaker assembly according to claim 3 wherein said housing and said base are interconnected by an axial spine.

14) A speaker assembly according to claim 13 wherein said housing and base are formed from a pair of plastic shells and covered by a metallic skin.

15) A speaker assembly according to claim 14 wherein said spine secures said skin to said shells.

16) A speaker assembly wherein said shells support said speakers.

17) A speaker assembly according to claim 16 wherein one of said shells associated with said housing includes a boss to receive said second speaker.

18) A speaker assembly according to claim 17 wherein said boss merges smoothly with an outer wall of said one of said she

19) A speaker assembly as claimed in claim 1, wherein said body includes a speaker housing and a base, said base including reflecting surface and a support projecting upwardly from said base, said housing being suspended from a line connected to said support, to maintain said housing in spaced relationship from said reflecting surface.

20) A speaker assembly as claimed in claim 19, wherein said reflecting surface is roughly conical.

21) A speaker assembly as claimed in claim 19, wherein said reflecting surface is a cone.

22) A speaker assembly as claimed in claim 21, wherein the conical centre of said reflecting surface is offset from the centre of said first speaker.

23) A speaker assembly as claimed in claim 19, wherein said reflecting surface is curved convexly.

24) A speaker assembly as claimed in claim 19, wherein said reflecting surface is aluminum.

25) A speaker assembly as claimed in claim 1 wherein said body is finished with a powder coat.

26) A speaker assembly as claimed in any preceding claim wherein said body has a diameter of between 4 inches (9.5 cm) and 4.5 inches (11 cm).

27) A speaker assembly as claimed in claim 26, wherein said body has a diameter of 4 inches (9.5 cm).

28) A speaker system as claimed in claim and a subwoofer for producing low frequency sound waves.
